(19) United States
(12) Patent Application Publication
(10) Pub. No.: US 2026/0204708 A1
(43) Pub. Date: Jul. 16, 2026

(54) Top cover for a battery pack with integrated reinforcements, battery pack and method to assemble the same

(71) Applicant: ArcelorMittal, Luxembourg (LU)

(72) Inventors: Qaiser KHAN, Novi, MI (US); Tianfu WANG, Mississauga, Ontario (CA)

(21) Appl. No.: 19/135,225

(22) PCT Filed: Dec. 7, 2022
(86) PCT No.: PCT/IB2022/061885

§ 371 Date: Jun. 3, 2025

(51) Int. Cl. H01M 50/242; H01M 50/204; H01M 50/244; H01M 50/249; H01M 50/276

(52) U.S. Cl. CPC H01M 50/242; H01M 50/204; H01M 50/244; H01M 50/249; H01M 50/276; H01M 2220/20

(57) ABSTRACT

Top cover assembly of a battery pack including: a top cover generally having an inverted tub shape, an inner reinforcement structure including at least one transverse inner reinforcement element extending inside the top cover in a substantially transverse direction, and an outer reinforcement structure including at least left and right outer reinforcement elements.

The present invention relates to a battery pack for an electric vehicle and in particular to the design of the top cover of said battery pack, the overall design of said battery pack and the assembly process of said battery pack.

### BACKGROUND

Electric vehicles are an answer to the ever-pressing request to diminish the carbon footprint of individual mobility. The battery pack, located below the floor panel, is a key element of said electric vehicles. One of the foremost challenges that battery packs need to address, is optimizing the structural resistance of the pack while keeping the highest possible battery cell capacity. Indeed, reinforcing the battery pack involves adding structural elements, such as cross beams etc., which take up space at the expense of battery cells capacity.

### SUMMARY OF THE INVENTION

The current invention provides for an innovative battery pack design, in particular an innovative design of the battery pack top cover, which allows to maximize cell space while guaranteeing excellent structural resistance of the pack.

The current invention also provides for an innovative assembly sequence of a battery pack, which simplifies the overall process, leading to productivity gains and cost savings.

The present invention provides a battery pack for an electric vehicle comprising a top cover assembly made of steel and designed to be assembled to a battery tray assembly supporting energy storage units for said electric vehicle, said top cover assembly comprising:
a top cover generally having an inverted tub shape and consisting of a top plate generally extending in a horizontal plane bordered by left and right side walls and front and back side walls such as the height in the elevation direction of said side walls is at least 0.5 times the height between the lowest point of the battery tray assembly and the highest point of the top cover assembly, said side walls being prolonged by four flanges generally extending in a horizontal plane,
an inner reinforcement structure comprising at least one transverse inner reinforcement element extending inside the top cover in a substantially transverse direction between the left and right side walls,
an outer reinforcement structure comprising at least left and right outer reinforcement elements each of said outer reinforcement elements comprising at least a side portion extending over at least a portion of the outside of said left and right side walls, such that the surface area of each of said outer reinforcement side portions is at least equal to 0.75 the surface area of the corresponding side wall over which it extends.

The present invention also provides a process to manufacture a battery pack according to the invention comprising the steps of:
providing a top cover assembly as provided above,
providing a battery tray assembly to which energy storage units have been attached,
attaching said top cover assembly to said battery tray assembly by securing them together at least along flanges respectively of the top cover assembly and of the battery tray assembly.

### BRIEF DESCRIPTION OF THE DRAWINGS

Other aspects and advantages of the present invention will appear upon reading the following description, given by way of example, and made in reference to the appended drawings, which are in no way limitative, wherein:

FIG. 1 is an overall perspective view of an electric vehicle indicating the position of the battery pack.

FIG. 2 is a perspective view of an embodiment of the battery pack according to the present invention representing the top cover assembly and the battery tray assembly before they are assembled together.

FIG. 3 is a perspective view of an embodiment of the top cover assembly according to the present invention.

FIG. 4 is a perspective exploded view of an embodiment of the top cover assembly according to the present invention.

FIG. 5 is a perspective view of an embodiment of a corner of the top cover assembly according to the present invention.

FIG. 6 is a perspective view of an embodiment of the battery tray assembly according to the present invention.

FIG. 7 is a perspective exploded view of an embodiment of the battery tray assembly according to the present invention.

FIGS. 8 and 9 represent an embodiment of the assembly process of a battery pack according to the present invention.

### DETAILED DESCRIPTION

In the following descriptions and claims, the directional terms are defined according to the usual directions of a mounted vehicle.

In particular, the terms “top”, “up”, “upper”, “above”, “bottom”, “low”, “lower”, “below” etc. are defined according to the elevation direction of a vehicle. The terms “front”, “back”, “rear”, “front”, “forward”, backward” etc. are defined according to the longitudinal direction of a vehicle, i.e. the direction in which the vehicle moves forward when following a straight line. The terms “left”, “right”, “transverse”, etc. are defined according to the orientation parallel to the width of the vehicle. The terms “inner”, “outer” are to be understood according to the width direction of the vehicle: the “inner” is closest to the central axis of the vehicle, i.e. closest to the inside of the vehicle, whereas the “outer” is located further away from said central axis of the vehicle, in effect closer to the outside of the vehicle. The same applies to the terms “distal” and “central”: the “distal” part is located closest to the outside of the vehicle and the “central” part closest to the center of the vehicle. The term “horizontal” refers to the orientation of the plane comprising the longitudinal and the transverse directions. The term “vertical” refers to any orientation comprising the elevation direction.

In the following figures, the orientations and spatial references are all made using an X, Y, Z coordinates referential, wherein Z is the elevation direction of the vehicle, X is the longitudinal direction of the vehicle and Y is the transverse direction of the vehicle. The referential is represented in each figure. When the figure is a 2D flat representation, the axis which is outside of the figure is represented by a dot in a circle when it is pointing towards the reader and by a cross in a circle when it is pointing away from the reader, following established conventions.

By “substantially parallel” or “substantially perpendicular” it is meant a direction which can deviate from the parallel or perpendicular direction by no more than 15°.

A steel sheet refers to a flat sheet of steel. It has a top and bottom face, which are also referred to as a top and bottom side or as a top and bottom surface. The distance between said faces is designated as the thickness of the sheet. The thickness can be measured for example using a micrometer, the spindle and anvil of which are placed on the top and bottom faces. In a similar way, the thickness can also be measured on a formed part.

By average thickness of a part, or of a portion of a part, it is meant the overall average thickness of the material making up the part after it has been formed into a 3-dimensional part from an initially flat sheet.

Tailor welded blanks are made by assembling together, for example by laser welding, several sheets or cut-out blanks of steel, known as sub-blanks, in order to optimize the performance of the part in its different areas, to reduce overall part weight, to reduce overall part cost and to reduce material scrap. The sub-blanks forming the tailor welded blanks can be assembled with or without overlap, for example they can be laser butt-welded (no overlap), or they can be spot-welded to one another (with overlap).

By opposition to a tailor welded blank, a monolithic blank refers to a blank which consists of one single sub-blank, without several sub-blanks being combined together.

A tailor rolled blank is a blank having multiple sheet thicknesses obtained by differential rolling during the steel sheet production process.

The ultimate tensile strength, the yield strength and the elongation are measured according to ISO standard ISO 6892-1, published in October 2009. The tensile test specimens are cut-out from flat areas. If necessary, small size tensile test samples are taken to accommodate for the total available flat area on the part.

The bending angle is measured according to the VDA-238 bending standard. For the same material, the bending angle depends on the thickness. For the sake of simplicity, the bending angle values of the current invention refer to a thickness of 1.5 mm. If the thickness is different than 1.5 mm, the bending angle value needs to be normalized to 1.5 mm by the following calculation where α1.5 is the bending angle normalized at 1.5 mm, t is the thickness, and at is the bending angle for thickness t:

$$α 1. 5 = ( α t \times √ t ) / √ 1.5$$

Cold stamping is a forming technology for metals which involves shaping a metallic sheet into a formed part by pressing it between an upper and lower die, called the cold stamping tool. For example, the cold stamping tool has a blank holder which allows to hold the metallic sheet on its sides. For example, the cold stamping tool consists of several steps, each involving an upper and lower die to produce complex shapes and/or to perform further operations such as punching holes in the part or trimming its sides. Other cold forming technologies exist such as for example roll forming, which involves bending a continuous sheet between a successive set of rolls, simple bending which involves simply bending a sheet of steel using a press and an upper and lower bending tool etc.

Roll forming is a continuous metal forming process taking a sheet, a strip, or a coil and bending or forming it to a continuous cross section. The process is performed between successive pairs of rolls that change the shape until the desired section is completed. Said section is called the roll forming section and the direction in which the material is being roll formed, i.e. the direction separating two successive pairs of rolls, is called the roll forming direction.

Hot stamping is a forming technology for steel which involves heating a blank of steel, or a preformed part made from a blank of steel, up to a temperature at which the microstructure of the steel has at least partially transformed to austenite, forming the blank or preformed part at high temperature by stamping it and simultaneously quenching the formed part to obtain a microstructure having a very high strength, possibly with an additional partitioning or tempering step in the heat treatment.

A multistep hot stamping process is a particular type of hot stamping process including at least one stamping step and consisting of at least two process steps performed at high temperature, above 300° C. For example, a multistep process can involve a first stamping operation and a subsequent hot trimming operation, so that the finished part, at the exit of the hot stamping process, does not need to be further trimmed. For example, a multistep process can involve several successive stamping steps in order to manufacture parts having more complex shapes than what can be realized using a single stamping operation. For example, the parts are automatically transferred from one operation to another in a multistep process, for example using a transfer press. For example, the parts stay in the same tool, which is a multipurpose tool that can perform the different operations, such as a first stamping and a subsequent in-tool trimming operation.

A partial hardening hot stamping process is a hot stamping process in which the heat profile to which the blank is submitted is purposely tailored to be different in different areas of the blank, in order to obtain different material properties in these different areas at the end of the hot stamping process. For example, this allows to produce hot stamped parts using a single metallic blank made of a single material which will have different levels of hardness and elongation in different areas of the final part. For example, this allows to produce parts having soft zones and hard zones, said soft zones being able to deform under an impact load in order to absorb energy, whereas said hard zones will resist intrusion by resisting deformation. There are several different technologies to implement partial hardening. For example, the material can be heated at different temperatures in different areas of the blank, the higher temperature areas will be fully austenitic at the exit of the austenitizing furnace resulting in a very hard microstructure after hot stamping, whereas the lower temperature areas will have an intercritical ferrite/austenite microstructure at the exit of the austenitizing furnace resulting in a lower hardness microstructure after hot stamping. For example, the material can be quenched at different quenching speeds in different areas of the blank during the hot stamping step itself, the areas quenched at a higher quenching speed will have a higher hardness than those quenched at a lower speed.

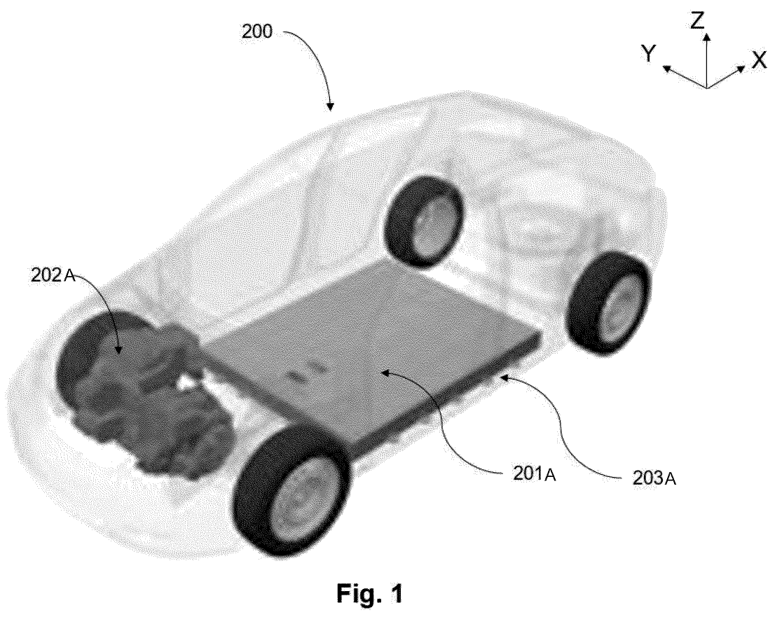

Referring to FIG. 1, an electric vehicle 200 has a battery pack 201A located below the floor panel. Said electric vehicle for example has a front electric motor 202A, powered by the energy storage units located inside the battery pack 201A. The battery pack 201A is attached to the vehicle structure on its side, generally by assembling it to the left and right rocker assemblies 203A of the vehicle (also known as side sills), which are long longitudinal assemblies, often consisting of several parts assembled together. The rocker assemblies 203A run along the lower edge of the body in white in between the front and rear wheel housings. The object of the present invention relates to the design of said battery pack 201A and to a method to assemble said battery pack.

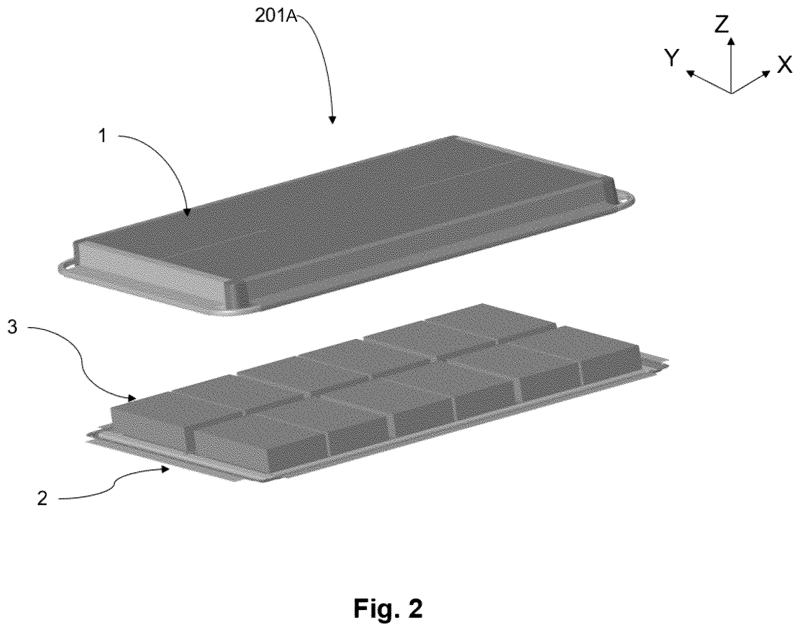

Referring to FIG. 2, the battery pack 201A comprises at least a top cover assembly 1 and a battery tray assembly 2, to which are attached energy storage units 3. Said energy storage units 3 contain the battery cells that are used to power the vehicle. In a specific embodiment, the energy storage units 3 are made up of the battery cells themselves, in what is called a cell to pack concept. In a specific embodiment, the energy storage units 3 consist of the battery cells and a packaging element to protect these cells, known as a battery module—this is what is known as a module to pack architecture. The present invention is compatible with both cell to pack and module to pack architectures, thanks to the fact that it provides for a fully reinforced battery pack, which can efficiently protect the battery cells directly, without the need for specifically reinforced modules.

It is of paramount importance to protect the energy storage units 3 in case the vehicle is involved in a crash. Indeed, any damage to the energy storage units 3 may result in toxic chemical leaks, toxic fume emissions and can result in electrical or fire hazards. For the safety of the occupants and the surroundings, the energy storage units 3 must be kept safe from harm even in the case of violent collisions. This is the role of the battery pack itself.

It is known from the prior art, see for example patent application WO2018153781, to provide a reinforced battery tray assembly having inner and outer reinforcement elements to protect the energy storage units and to provide a non-structural top cover to the battery pack, which acts merely as a closing plate.

There are several drawbacks associated to such design. One drawback is that the battery pack can be attached to the vehicle body in white only by securing it by its bottom part, which is reinforced. While this is not an issue when attaching it to the rocker assemblies, it proves problematic when attaching it to the floor panel or floor reinforcements, because it means running fixtures through the entire height of the battery pack. In practice, the battery pack is very often attached at least in part to the floor panel or floor reinforcement structure. Indeed, it allows to distribute the load of the very heavy battery pack (typically around 500 kg) over a large area of the bottom part of the body in white. It also helps to improve the Noise Vibration Harshness (NVH) performance of the vehicle: without central attachments to the floor panel or floor reinforcement, the battery pack sags between the rocker panels and vibrates up and down when the vehicle is running, which greatly affects the comfort of the passengers and also puts additional pressure on the attachments to the rocker panel. Another identified drawback to the above-described design is related to the presence of top flanges in such architectures, which extend horizontally at the top of the side walls of the reinforced battery tray and serve as assembly area between the tray and the top cover. Because said flanges are located towards the top of the battery pack, they take up space in the volume located between the left and right rocker elements. Said volume occupied by the assembly flanges is not available for the energy storage units, which diminishes the total energy storage capacity of the battery pack, and as a consequence lowers the driving autonomy of the vehicle.

The present invention aims to overcome the identified drawbacks of the prior art by providing a battery pack with a reinforced top cover assembly and with assembly flanges between the top cover assembly and the battery tray assembly located towards the bottom of the battery pack. By applying the current invention, it is possible to manufacture a battery pack which can be attached to the rest of the vehicle in a very versatile way, by the bottom, the side or the top or a combination of the three possibilities. Furthermore, the assembly flange between the top cover assembly and the tray assembly being located towards the bottom of the battery pack, it can slide underneath the packaging volume occupied by the rocker assemblies and therefore allow for the full transversal space between the bulk of the rocker assemblies to be made available for energy storage units, thereby maximizing the amount of energy storage units that can fit within the battery pack.

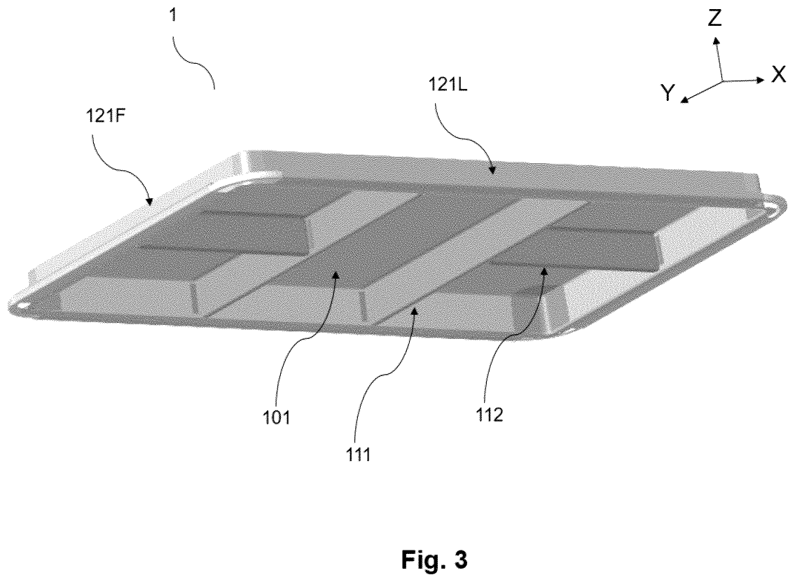

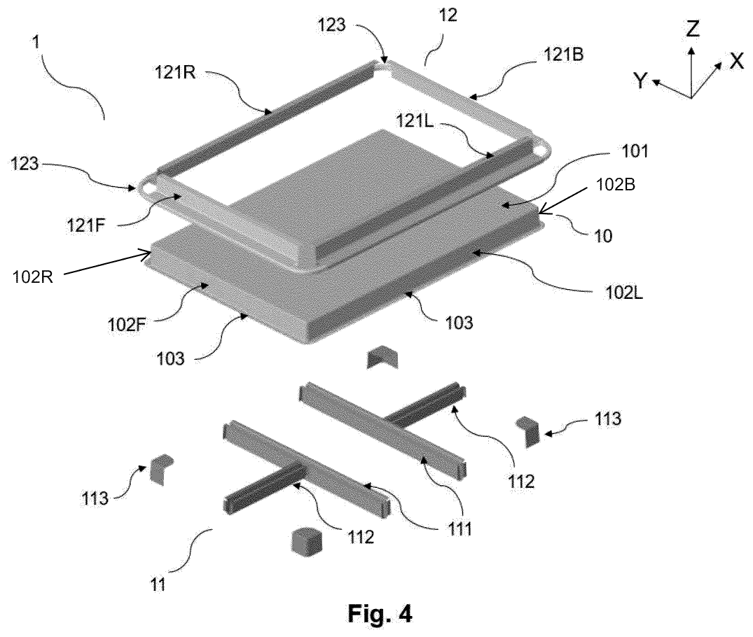

Referring to FIGS. 3 and 4, the top cover assembly according to the invention comprises:
a top cover 10 (see FIG. 4) generally having an inverted tub shape and consisting of a top plate 101 generally extending in a horizontal plane bordered by left and right side walls 102L, 102R, and front and back side walls 102F, 102B such as the height in the elevation direction of said side walls 102L, 102R, 102F, 102B is at least 0.5 times, preferably 0.75 times, the height between the lowest point of the battery tray assembly 2 and the highest point of the top cover assembly 1, said side walls 102L, 102R, 102F, 102B being prolonged by four flanges 103 generally extending in a horizontal plane,
an inner reinforcement structure 11, located inside the top cover 10, i.e. below the top plate 101, comprising at least one transverse inner reinforcement element 111 extending in a substantially transverse direction between said left and right side walls of the top cover 102L, 102R, and
an outer reinforcement structure 12, located outside of the top cover 10, i.e. above the top cover 10, comprising at least left and right outer reinforcement elements 121L, 121R, each of said outer reinforcement elements 121L, 121R comprising at least a side portion 1212 extending over at least a portion of said left and right side walls 102L, 102R, such that the surface area of each of said outer reinforcement side portions 1212 is at least equal to 0.75, preferably 0.8, even more preferentially 0.9, the surface area of the corresponding side wall over which it extends.

The top cover assembly according to the invention is particularity well reinforced on its left and right sides in order to resist intrusions into the battery pack in the case of side impacts. Generally speaking, side impacts are most critical for the battery pack because the side of the battery pack is close to the outside of the vehicle and only protected by the rocker assembly. The front and back ends of the battery pack are less exposed to direct intrusion from outside impactors in as much as there is a front and rear crash management system in between the impactor and the battery pack. However, the front and back ends of the battery pack will still be exposed to crash energy transmitted by said front and rear crash management system—it can therefore be advantageous to also further reinforce these areas by the outer reinforcement structure 12. Therefore, in a particular embodiment, the outer reinforcement structure 12 further comprises back and front outer reinforcement elements 121B, 121F, each comprising at least a side portion 1212 extending over at least a portion of the back and front side walls 102B, 102F. In a particular embodiment, at least one of the back or front reinforcement element side portion 1212B, 1212F extends over a surface covering at least 80%, preferably 90%, of the respective side wall surface along which it extends.

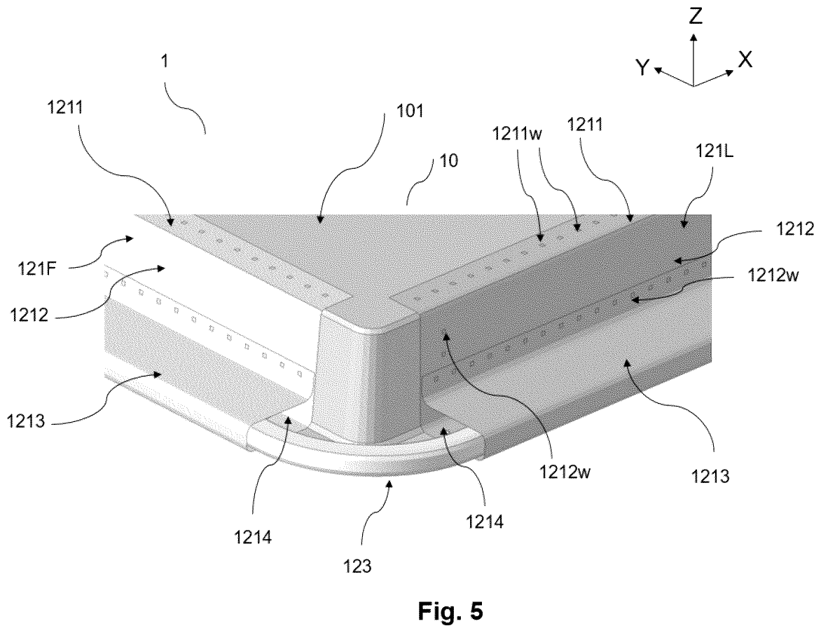

The outer reinforcement elements 121L, 121R, 121B, 121F are assembled to the top over 10 for example by spot welding. As depicted on FIG. 5, spot welding can be performed for example to attach an outer reinforcement top portion 1211 (said top portion overlapping the top plate 101) to the top plate 101 by spot welds 1211w. Spot welding can also be performed for example to attach the outer reinforcement side wall portion 1212 to the corresponding side wall by spot welds 1212w.

Thanks to the use of an inverted tub design with high side walls, it is possible to position the flanges 103 used to assemble the top cover assembly to the battery tray assembly towards the bottom of the battery pack. This allows to possibly slide the left and right flanges 103 below the left and right rocker assembly packaging space, which in turn allows to provide more space for the energy storage units 3, as explained previously.

By providing a reinforced top cover assembly, the current invention allows to assemble the battery pack to the rest of the vehicle directly by the top or the reinforced sides of the top cover, which is very beneficial when assembling the battery pack directly to the floor panel or the floor reinforcement elements. This allows, as previously described, to improve the NVH performance of the vehicle and to efficiently distribute the load of the battery pack.

Thanks to the presence of an inner reinforcement structure 11 comprising at least one inner transverse reinforcement element 111 extending between the left and right side walls 102L, 102R of the top cover, the reinforced top cover can resist to side impacts with little deformation, thereby efficiently protecting the energy storage units 3. In a particular embodiment, as depicted on FIGS. 3 and 4, the inner reinforcement structure 11 comprises at least two transverse inner reinforcement elements 111 spaced apart from one another in the longitudinal direction. Advantageously this allows to provide a higher resistance to intrusion and deformation of the battery pack in case of a side impact. Furthermore, the presence of transverse reinforcement elements in different positions in the longitudinal direction allows to prevent deformation in the case of side impacts located in varying positions in the longitudinal direction, thereby making the battery pack more robust in case of different side impact scenarios. It also affords a higher overall rigidity to the battery pack.

In a particular embodiment, such as is depicted on FIGS. 3 and 4, the inner reinforcement structure 11 further comprises a longitudinal reinforcement element 112 extending in between the back side wall 102B and a transverse reinforcement element 111 and at least a longitudinal reinforcement element 112 extending in between the front side wall 102F and a transverse reinforcement element 111. Advantageously, this allows to reinforce the battery pack in the case of a front or rear impact.

Thanks to the presence of a lateral outer reinforcement structure 12, the battery pack can be efficiently attached to the rest of the vehicle in a versatile way, as previously described. Furthermore, the outer reinforcement structure 12 allows to resist deformation of the battery pack and intrusion into the pack, while at the same time distributing the load of a side, front or rear impact to the rest of the reinforcement structure and transmitting it to the inner reinforcement structure 11.

In a particular embodiment, such as depicted on FIG. 5, at least one of the outer reinforcement elements 121L, 121R, optionally 121F, 121B comprise a flange portion 1213 extending over at least a portion of the corresponding flange 103 of the top cover. Said flange portion 1213 can extend further outwards than the 103 over which it extends, such as depicted on FIG. 5. Advantageously, the presence of such an outer reinforcement flange portion 1213 allows to further reinforce the top cover assembly 1, it can also serve as attached point to the vehicle structure, for example to the rocker assembly in the case of the left and right outer reinforcement elements 121L, 121R. In a particular embodiment, as depicted on FIG. 5, said flange portion 1213 comprises a closed section portion enclosing a hollow volume 1214. For example, this is done by manufacturing the outer reinforcement element by roll forming, which allows to create a closed section portion within the outer reinforcement element—the outer reinforcement elements depicted on FIG. 5 for example can be manufactured by roll forming. Advantageously, the presence of a hollow volume 1214 within the flange portion 1213 allows to very efficiently resist compressive efforts exerted applied in a direction substantially perpendicular to a side wall of the top cover, such as occurs on the left or right reinforcement elements 121L, 121R in the case of a side impact for example. The presence of a hollow volume 1214 also confers increased rigidity to the corresponding reinforcement element.

In a particular embodiment, the outer reinforcement structure 12 further comprises outer corner reinforcements 123, as depicted on FIGS. 3 to 5. Said outer corner reinforcements 123 are attached to two neighboring outer reinforcement elements. For example, there is an outer corner reinforcement between at least one of the following outer reinforcement elements:
the front outer reinforcement 121F and the left outer reinforcement element 121L,
the left outer reinforcement element 121L and the back outer reinforcement 121B,
the back outer reinforcement 121B and the right outer reinforcement 121R, and
the right outer reinforcement 121R and the front outer reinforcement 121F.

In a particular embodiment, there are outer corner reinforcements 123 in all four of the above-described possible locations, in other words in all four corners of the outer reinforcement structure 12.

Advantageously, the outer corner reinforcements allow to further reinforce the structure and ensure that the different reinforcement elements 121L, 121R, 121F, 121B of the outer reinforcement structure 12 cooperate with each other in case of impact. Indeed, if for example the battery pack is impacted on its left side, the presence of outer corner reinforcement between the left outer reinforcement element 121L and the back outer reinforcement 121B and between the left outer reinforcement element 121L and the front outer reinforcement 121F will ensure that the displacement of the impacted left outer reinforcement 121L will be limited by the resistance to deformation of the front and back outer reinforcements. Furthermore, if outer corner reinforcements are present in all four corners, the outer reinforcement structure 12 will form a rigid ring structure which will increase the overall rigidity of the assembly.

For example, the outer corner reinforcements 123 are attached to the flange portion 1213 of the corresponding outer reinforcement elements, as depicted on FIGS. 3, 4 and 5. Other configurations are possible. For example, the outer corner reinforcements 123 are attached to the side wall portion 1212 of the corresponding outer reinforcement elements.

In a particular embodiment, such as depicted on FIG. 5, the outer corner reinforcements 123 are assembled by inserting them and attaching them to the hollow volumes 1214 of the corresponding outer reinforcement elements. Advantageously, this allows for a very tight connection and presents several industrial advantages, such as for example ease of positioning the elements to be assembled (for example: the corner reinforcements 123 being force fitted in the 2 adjacent hollow volumes 1214 and held in place against the outermost wall of the closed sections enclosing said hollow volumes 1214 before being assembled).

In a particular embodiment, the inner reinforcement structure 11 further comprises inner corner reinforcements 113, such as depicted on FIG. 4. Said inner corner reinforcements 113 are located in the corners of the inner reinforcement structure and are attached to at least two portions of the top cover 10 extending in different planes. For example, an inner corner reinforcement 113 can be attached to the top plate 101 and one of side walls 102L, 102R, 102F, 102B. For example, an inner corner reinforcement 113 can be attached to two adjacent side walls, such as for example the left side wall 102L and the front side wall 102F. For example, an inner corner reinforcement 113 can be attached simultaneously to three different portions of the top cover 10, the top plate 101 and two adjacent side walls—this is the case of the inner corner reinforcements depicted on FIG. 4. In a particular embodiment, inner corner reinforcements are located in all four corners of the inner reinforcement structure 11.

Advantageously, the presence of said inner corner reinforcements allows to increase the resistance to deformation under impact of the reinforced top cover and allow to increase the rigidity of the top cover.

The battery pack 201A according to the invention comprises a top cover assembly 1 having the previously described characteristics and a battery tray assembly 2, to which are attached energy storage units 3. A battery pack commonly comprises additional elements, not detailed in the current invention, such as for example a lower shield, located at the very bottom of the battery pack and acting to prevent any possible intrusion coming from below the battery pack. It also usually comprises a cooling circuit, usually located on or below the tray, acting to regulate the temperature of the energy storage units, which needs to be kept as close to possible to the optimal operating temperature of the battery cells.

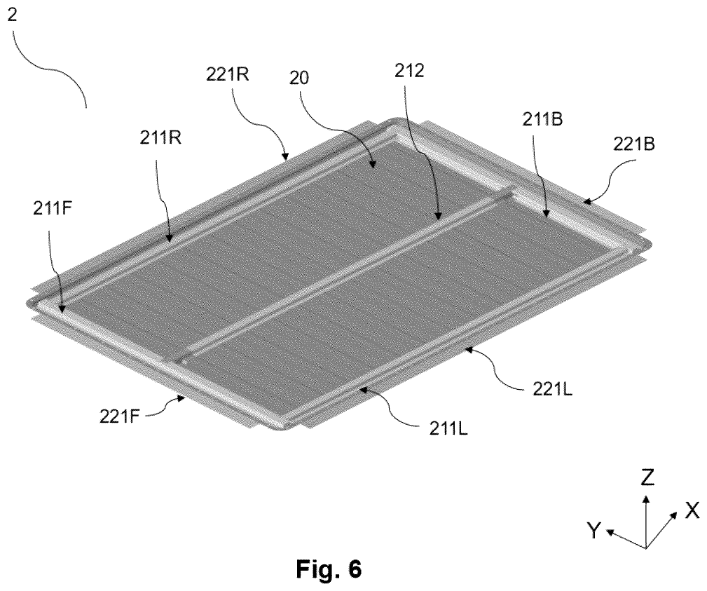

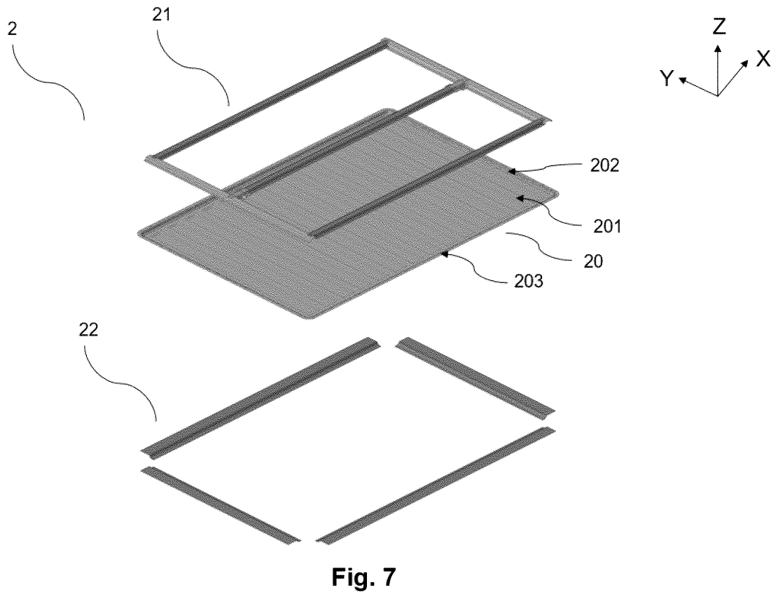

Referring to FIGS. 6 and 7, the battery tray assembly 2 comprises the battery tray 20 itself, which has a shallow tub shape, with a flat or corrugated bottom part 201, surrounded by shallow side walls 202, prolonged by horizontal flanges 203. The purpose of having a corrugated tray bottom 201 is to increase the rigidity of the part and also possibly make room for the cooling system. The corrugations can also play a role in assembling the battery tray to the lower part of the battery pack structure, namely a shield possibly equipped with reinforcing cross-members. The battery tray 20 does not play a structural role itself, its purpose is to support the energy storage units 3.

In order to reinforce the battery tray 20 itself, a battery tray inner reinforcement structure 21 and outer reinforcement structure 22 are provided. Said inner reinforcement structure 21 consists of elements which are attached inside the battery tray hollow tub, i.e. on top of the tray itself. Said outer reinforcement structure 22 consists of elements which are attached outside the battery tray shallow tub, i.e. below the tray.

The battery tray inner reinforcement structure 21 comprises at least left and right inner lateral reinforcement elements 211L, 211R and optionally additional front and/or back inner lateral reinforcement elements 211F, 211B. Said inner lateral reinforcement elements 211L, 211R, 211F, 211B cover at least part of the tray bottom 201 and optionally at least part of the corresponding side wall 202 and at least a portion of the corresponding flange 203. The inner lateral reinforcement elements 211L, 211R, 211F, 211B provide further reinforcements to protect the energy storage units 3 in case of a crash and rigidity to the battery tray assembly 2. They can also serve as elements to which the energy storage units 3 are attached.

The inner reinforcement structure 21 optionally further comprises at least one traversing reinforcement element 212, attached to the tray bottom 201 and to two opposite side walls 202 or two opposite lateral reinforcement elements 244, such as depicted on FIGS. 6 and 7—said traversing reinforcement element can be longitudinal (as depicted, the reinforcement element 212 of FIG. 6 is attached in between the opposing lateral reinforcement elements 211F and 211B) or transverse. Said optional traversing reinforcement elements 212 serve to further reinforce and rigidify the tray bottom 201 which is a large part bearing the heavy weight of the energy storage units 3. They can also serve as elements to which the energy storage units 3 are attached.

The battery tray outer reinforcement structure 22 comprises at least left and right lateral outer reinforcement elements 221L, 221R and optionally back and/or front lateral outer reinforcement elements 221F, 221B covering at least part of the corresponding side wall 202 of the battery tray 20 and optionally at least a portion of the corresponding flange 203 and optionally a portion of the tray bottom itself 201.

The top cover assembly 1 and the bottom tray assembly 2 are assembled by attaching them together at least along their respective flanges 103, 203. For example, they are attached by spot welding them along said flanges. For example, they are attached by mechanically fastening them along said flanges, for example by bolting, riveting, etc. For example they are attached by both spot welding and mechanical fastening techniques.

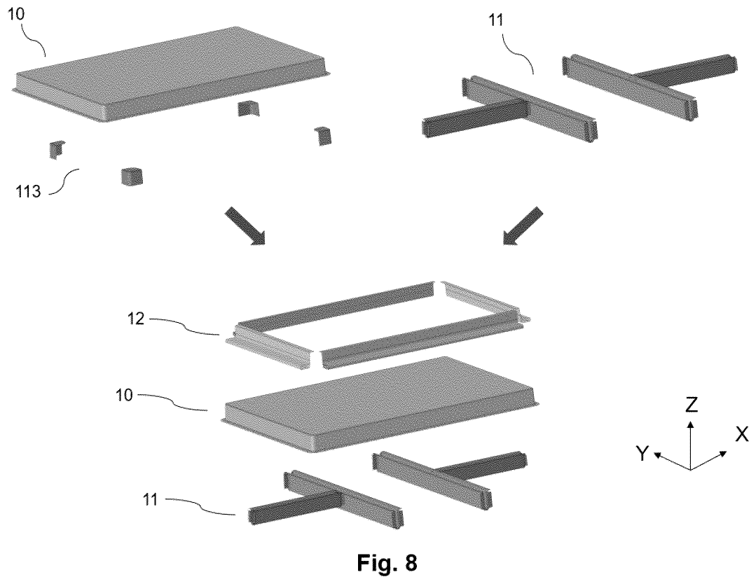

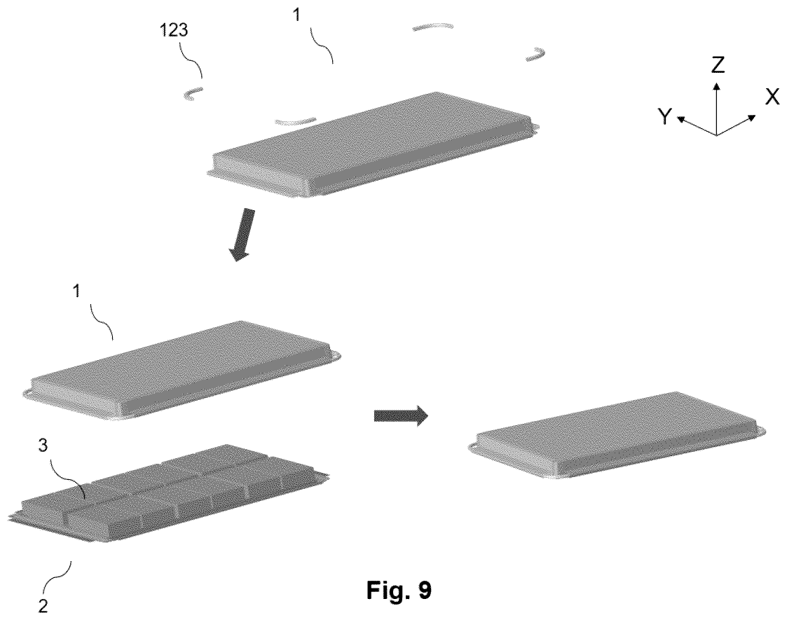

In order to assemble the reinforced battery pack according to the invention, the following assembly sequence is followed as depicted on FIGS. 8 and 9:

Optionally, if inner corner reinforcements 113 are used, the top cover 10 and the inner corner reinforcements 113 are assembled together, for example by spot welding, as depicted on the upper left hand side of FIG. 8.

An inner reinforcement structure 11 is provided, as depicted on the upper right hand side of FIG. 8. For example, said inner reinforcement structure 11 is manufactured by assembling together transverse reinforcements 111 and longitudinal reinforcements 112. Said reinforcements are assembled together for example by spot welding. In a particular embodiment, brackets are used between the parts to be assembled and serve as connecting elements between two reinforcing elements—in the configuration, said brackets are provided with two sets of flanges on opposite sides of the bracket each set facing one of the parts to be assembled—the parts are assembled by welding them to the brackets using said flanges as weld surfaces. In a particular embodiment, the inner reinforcement structure 11 further comprises brackets on the surfaces to be welded to the top cover 10, so that they can be assembled to the top cover in the subsequent step using said brackets.

The outer reinforcement structure 12, the top cover 10 and the inner reinforcement structure 11 are assembled together, for example by spot welding, as depicted on the bottom of FIG. 8.

Optionally, if outer corner reinforcements 123 are used, said outer corner reinforcements 123 are added by attaching them to the outer reinforcement structure 12 already mounted on the top cover 10, as depicted on the top of FIG. 9. For example the outer corner reinforcements 123 are each welded or bolted to two successive outer reinforcement elements.

The thus assembled top cover assembly 1 is then assembled to the battery tray assembly 2, on which the energy storage units 3 have been fixed, as depicted on the bottom of FIG. 9. The assembly is performed at least by attaching the top cover assembly 1 and the battery tray assembly 2 along their respective flanges 103, 203. Said assembly is performed for example by spot welding or by mechanical fastening, such as by bolting, or using a combination of both techniques.

In a specific embodiment, in order to prevent any water ingress inside the battery pack, which would damage the energy storage units, and in order to ensure conversely that none of the chemicals located within the energy storage units leak out of the battery pack, sealant is applied to cover at least the sides of the flanges 103, 203.

In a specific embodiment the following materials are used to manufacture the above-described elements of the top cover assembly 1 and the battery tray assembly 2 according to the invention:

Steel having a chemical composition comprising in weight %: 0.13%<C<0.25%, 2.0%<Mn<3.0%, 1.2%<Si<2.5%, 0.02%<Al<1.0%, with 1.22%<Si+Al<2.5%, Nb<0.05%, Cr<0.5%, Mo<0.5%, Ti<0.05%, the remainder being Fe and unavoidable impurities and having a microstructure comprising between 8% and 15% of retained austenite, the remainder being ferrite, martensite and bainite, wherein the sum of martensite and bainite fractions is comprised between 70% and 92%. With this composition, the steel sheet has, as measured in the rolling direction, a yield strength comprised between 600 MPa and 750 MPa and an ultimate tensile strength comprised between 980 MPa and 1300 MPa while keeping a total elongation above 19%. For example, this material is used at least for part of the elements making up the outer reinforcement structures 12, 22 or the inner reinforcement structures 11, 21.

Steel having a chemical composition comprising in weight %: %: 0.15%<C<0.25%, 1.4%<Mn<2.6%, 0.6%<Si<1.5%, 0.02%<Al<1.0%, with 1.0%<Si+Al<2.4%, Nb<0.05%, Cr<0.5%, Mo<0.5%, the remainder being Fe and unavoidable impurities and having a microstructure comprising between 10% and 20% of retained austenite, the remainder being ferrite, martensite and bainite. With this composition, the steel sheet has, as measured in the rolling direction, a yield strength comprised between 850 MPa and 1060 MPa and an ultimate tensile strength comprised between 1180 MPa and 1330 MPa while keeping a total elongation above 13%. For example, this material is used at least for part of the elements making up the outer reinforcement structures 12, 22 or the inner reinforcement structures 11, 21. For example the corresponding elements are made using such a steel by bending or stamping or roll forming them into the desired shape.

Fully martensitic steel wherein the composition of the fully martensitic steel comprises in % weight: 0.15%≤C≤0.5%. For example, this material is used at least for part of the elements making up the outer reinforcement structures 12, 22 or the inner reinforcement structures 11, 21. For example the corresponding elements are made using such a steel by roll forming them into the desired shape.

Dual phase steel having a microstructure comprising at least martensite and ferrite and having a UTS of at least 590 MPa. For example, this material is used at least for part of the elements making up the outer reinforcement structures 12, 22 or the inner reinforcement structures 11, 21.

Dual phase steel having a microstructure comprising at least martensite and ferrite and having a UTS of at least 780 MPa. For example, this material is used at least for part of the elements making up the outer reinforcement structures 12, 22 or the inner reinforcement structures 11, 21.

Dual phase steel having a microstructure comprising at least martensite and ferrite and having a UTS of at least 980 MPa. For example, this material is used at least for part of the elements making up the outer reinforcement structures 12, 22 or the inner reinforcement structures 11, 21.

In a specific embodiment at least part of the elements making up the outer reinforcement structures 12, 22 or the inner reinforcement structures 11, 21 are made by hot stamping or by multistep hot stamping or by partial hardening hot stamping at least one of the following materials either in the form of monolithic blanks, tailor rolled blanks or combined in the form of tailor welded blanks:

Steel having a composition comprising in % weight: 0.06%≤C≤0.1%, 1%≤Mn≤2%, Si≤0.5%, Al≤0.1%, 0.02%≤Cr≤0.1%, 0.02%≤Nb≤0.1%, 0.0003%≤B≤0.01%, N≤0.01%, S≤0.003%, P≤0.020% less than 0.1% of Cu, Ni and Mo, the remainder being iron and unavoidable impurities resulting from the elaboration. With this composition range, the yield strength of the corresponding area after hot stamping is comprised between 700 and 950 MPa, the tensile strength between 950 MPa and 1200 MPa and the bending angle is above 75°.

Steel having an ultimate tensile strength after hot stamping which is comprised between 1300 MPa and 1650 MPa and a yield strength which is comprised between 950 MPa and 1250 MPa.

Steel having an ultimate tensile strength after hot stamping which is comprised between 1300 MPa and 1650 MPa, a yield strength which is comprised between 950 MPa and 1250 MPa and a bending angle which is above 75°.

Steel having a composition comprising in % weight: 0.20%≤C≤0.25%, 1.1%≤Mn≤1.4%, 0.15%≤Si≤0.35%, Cr≤0.30%, 0.020%≤Ti≤0.060%, 0.020%≤Al≤0.060%, S≤0.005%, P≤0.025%, 0.002%≤B≤0.004%, the remainder being iron and unavoidable impurities resulting from the elaboration. With this composition range, the ultimate tensile strength of the corresponding area of the part after hot stamping is comprised between 1300 MPa and 1650 MPa and the yield strength is comprised between 950 MPa and 1250 MPa.

Steel having a tensile strength after press-hardening higher than 1800 MPa.

Steel having a composition which comprises in % weight: 0.24%≤C≤0.38%, 0.40%≤Mn≤3%, 0.10%≤Si≤0.70%, 0.015%≤Al≤0.070%, Cr≤2%, 0.25%≤Ni≤2%, 0.015%≤Ti≤0.10%, Nb≤0.060%, 0.0005%≤B≤0.0040%, 0.003%≤N≤0.010%, S≤0.005%, P≤0.025%, %, the remainder being iron and unavoidable impurities resulting from the elaboration.

Steel having a composition which comprises in % weight: C: 0.15-0.25%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Mo≤0.40%, Nb≤0.08%, Ca≤0.1%, the remainder of the composition being iron and unavoidable impurities resulting from the smelting. With this composition range, the tensile strength of the corresponding area of the dash panel assembly after hot stamping is higher than 1350 MPa and the bending angle is higher than 70°.

Steel having a composition which comprises in % weight: C: 0.26-0.40%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Ni≤0.5%, Mo≤0.40%, Nb≤0.08%, Ca≤0.1% the remainder of the composition being iron and unavoidable impurities resulting from the smelting. With this composition range, the tensile strength of the corresponding area after hot stamping is higher than 1350 MPa and the bending angle is higher than 70°.

Steel having a composition which comprises in % weight: C: 0.2-0.34%, Mn: 0.50-1.24%, Si: 0.5-2%, P≤0.020%, S≤0.010%, N≤0.010%, and comprising optionally one or more of the following elements, by weight percent: Al: ≤0.2%, Cr≤0.8%, Nb≤0.06%, Ti≤0.06%, B≤0.005%, Mo≤0.35%, the remainder of the composition being iron and unavoidable impurities resulting from the smelting. With this composition range, the tensile strength of the corresponding after hot stamping is equal to or higher than 1000 MPa and the bending angle is higher than 55°.

Steel having a composition which comprises in % weight: C: 0.13-0.4%, Mn: 0.4-4.2%, Si: 0.1-2.5%, Cr≤2%, Mo≤0.65%, Nb≤0.1%, Al≤3.0%, Ti≤0.1%, B≤0.005%, P≤0.025%, S≤0.01%, N≤0.01%, Ni≤2.0%, Ca≤0.1%, W≤0.30%, V≤0.1%, Cu≤0.2%, and verifying the following combination: 114−68*C−18*Mn+20*Si−56*Cr−60*Ni−36*Al+38*Mo+79*Nb−17691*B<20, the remainder of the composition being iron and unavoidable impurities resulting from the smelting. For example, this composition is used when hot stamping the part using a multistep process.

Steel which is coated with an aluminum-based metallic coating. By aluminum based it is meant a coating that comprises at least 50% of aluminum in weight. For example, the metallic coating is an aluminum-based coating comprising 8-12% in weight of Si. For example, the metallic coating is applied by dipping the base material in a molten metallic bath. Advantageously, applying an aluminum-based metallic coating avoids the formation of surface scale during the heating step of the hot stamping process, which in turn allows to produce the parts by hot stamping without a subsequent sand blasting operation. Furthermore, the aluminum-based coating also provides corrosion protection to the part while in service on the vehicle.

Steel which is coated with an aluminum-based metallic coating comprising from 2.0 to 24.0% by weight of zinc, from 1.1 to 12.0% by weight of silicon, optionally from 0 to 8.0% by weight of magnesium, and optionally additional elements chosen from Pb, Ni, Zr, or Hf, the content by weight of each additional element being inferior to 0.3% by weight, the balance being aluminum and optionally unavoidable impurities. Advantageously, this type of metallic coating affords very good corrosion protection on the part, as well as a good surface aspect after hot stamping.

In a specific embodiment, at least part of the elements making up the outer reinforcement structures 12, 22 or the inner reinforcement structures 11, 21 are made by hot stamping a laser welded blank comprising at least one sub blank having an aluminum based metallic coating and said aluminum coated sub-blanks are prepared before-hand by ablating at least part of the metallic coating on the edges to be welded. Advantageously, this removes part of the aluminum present in the coating, which would pollute the weld seam and deteriorate its mechanical properties.

In a specific embodiment, at least part of the elements making up the outer reinforcement structures 12, 22 or the inner reinforcement structures 11, 21 are made by hot stamping a laser welded blank comprising at least one sub blank having at least one side topped with an emissivity increasing top layer. Said emissivity increasing top layer is applied on the outermost surface of said sub-blank. Said emissivity increasing top layer allows the surface of said sub blank to have a higher emissivity compared to the same sub-blank which is not coated with said emissivity increasing top layer. Said emissivity increasing top layer can be applied either on the top or the bottom side of a sub-blank. Said emissivity increasing top layer can also be applied on both sides of said sub-blank. If said sub-blank comprises a metallic coating, such as described previously, the emissivity increasing top layer is applied on top of said metallic coating. Indeed, for the emissivity increasing top layer to increase the emissivity of the surface, it needs to cover the outermost surface of the sub-blank. Advantageously, said emissivity increasing top layer will allow to increase the heating rate of said sub-blank and therefore increase the productivity of the heating step of the hot stamping process. When using several sub blanks of differing thicknesses, said emissivity increasing top layer is advantageously applied to the sub-blanks having the highest thickness in order to decrease the difference in heating time between the different sub-blanks and therefore increase productivity, increase the hot stamping process window and overall allow to obtain a final part having homogeneous surface properties.

What is claimed is:

1-12. (canceled)

13: A battery pack for an electric vehicle comprising:
a top cover assembly made of steel and designed to be assembled to a battery tray assembly supporting energy storage units for the electric vehicle, the top cover assembly including:
a top cover having an inverted tub shape and having a top plate extending in a horizontal plane bordered by left and right side walls, and front and back side walls, a height in the elevation direction of the left, right front and back side walls being at least 0.5 times a further height between a lowest point of the battery tray assembly and a highest point of the top cover assembly, the left, right front and back side walls being prolonged by four flanges extending in a further horizontal plane,
an inner reinforcement structure including at least one transverse inner reinforcement element extending inside the top cover in a transverse direction between the left and right side walls, and
an outer reinforcement structure including left and right outer reinforcement elements, each of the left and right outer reinforcement elements including at least a side portion extending over at least a portion of an outside of the left and right side walls such that a surface area of each of left and right outer reinforcement side portions is at least equal to 0.75 of a respective surface area of the left and right side wall respectively.

14: The battery pack as recited in claim 13 wherein the top cover assembly further includes back and front outer reinforcement elements each having a respective side portion extending over at least a portion of the back and front side walls respectively.

15: The battery pack as recited in claim 13 wherein the at least one transverse reinforcement element includes at least two transverse inner reinforcement elements spaced apart from one another in the longitudinal direction.

16: The battery pack as recited in claim 13 wherein the inner reinforcement structure further includes a first longitudinal reinforcement element extending in between the back side wall and a first of the at least one transverse reinforcement element and a second longitudinal reinforcement element extending in between the front side wall and a second transverse reinforcement element of the at least one transverse reinforcement element.

17: The battery pack as recited in claim 13 wherein at least one of the outer left and right outer reinforcement elements further includes a flange portion extending over at least a portion of a respective flange of the four flanges.

18: The battery pack as recited in claim 17 wherein said flange portion includes a closed section portion enclosing a hollow volume.

19: The battery pack as recited in claim 14 wherein the outer reinforcement structure further includes at least one outer corner reinforcement attached between two neighboring of the left, right, back and front outer reinforcement elements

20: The battery pack as recited in claim 19 wherein the at least one outer corner reinforcement structure includes four outer corner reinforcements at all four corners.

21: The battery pack as recited in claim 13 wherein the inner reinforcement structure includes at least one inner corner reinforcement located in a corner of the inner reinforcement structure and attached to at least two portions of the top cover extending in different planes.

22: The battery pack as recited in claim 21 wherein the at least one inner corner reinforcement includes four inner corner reinforcements at all four corners.

23: A process to manufacture a battery pack as recited in claim 13 comprising the steps of:
providing the top cover assembly;
providing the battery tray assembly;
attaching the top cover assembly to the battery tray assembly by securing them together at least along flanges respectively of the top cover assembly and of the battery tray assembly.
